(19) United States
(12) Patent Application Publication
(10) Pub. No.: US 2011/0032699 A1
(43) Pub. Date: Feb. 10, 2011

(54) LIGHTING ASSEMBLY

(75) Inventor: Joseph L. Ferguson, Cable, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/538,219

(22) Filed: Aug. 10, 2009

(51) Int. Cl. F21V 5/00

(52) U.S. Cl. 362/235

(57) ABSTRACT

In an embodiment, a lighting assembly includes a first lighting module including a plurality of light-emitting diodes (LEDs) and a plurality of optical elements. Each optical element is configured to refract light emitted by a corresponding one of the LEDs. The assembly further includes a cooling assembly adjacent the lighting module and configured to cool the first lighting module.

### BACKGROUND OF THE INVENTION

PAR-64 lamps are known for their ability to provide intense illumination. However, incandescent or halogen-based PAR-64 sealed-beam lamps have a short life and are throw-away items.

### SUMMARY OF THE INVENTION

In an embodiment, a lighting assembly includes a first lighting module including a plurality of light-emitting diodes (LEDs) and a plurality of optical elements. Each optical element is configured to refract light emitted by a corresponding one of the LEDs. The assembly further includes a cooling assembly adjacent the lighting module and configured to cool the first lighting module.

### BRIEF DESCRIPTION OF THE DRAWINGS

Preferred and alternative embodiments are described in detail below with reference to the following drawings:

FIG. 1 illustrates a side view of a lighting assembly according to an embodiment of the invention;

FIG. 2 illustrates a top plan view of a lighting module according to an embodiment;

FIG. 3 illustrates an exploded front perspective view of an embodiment; and

FIG. 4 illustrates a rear perspective view of an embodiment.

### DETAILED DESCRIPTION OF THE PREFERRED EMBODIMENT

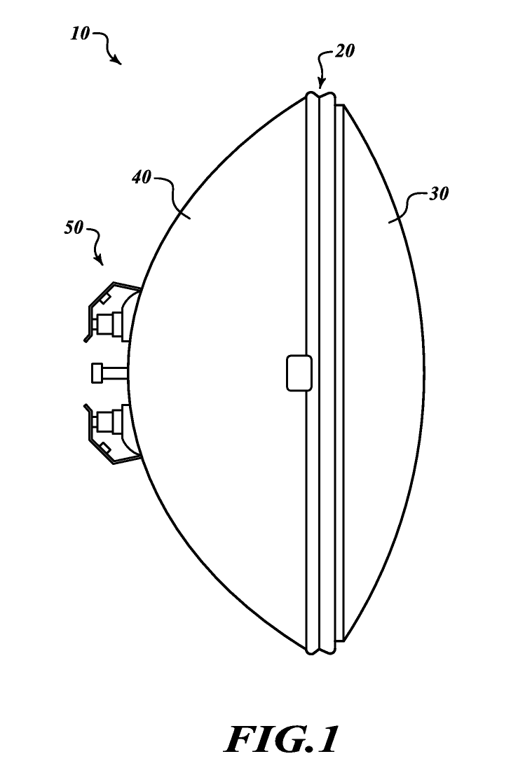

FIG. 1 illustrates a side view of a lighting assembly 10 according to an embodiment of the invention. Assembly 10 includes a main casing 20, a primary lens 30, and a rear casing 40 on which are mounted power terminals 50. Assembly 10 may be of a conventional PAR-64 configuration.

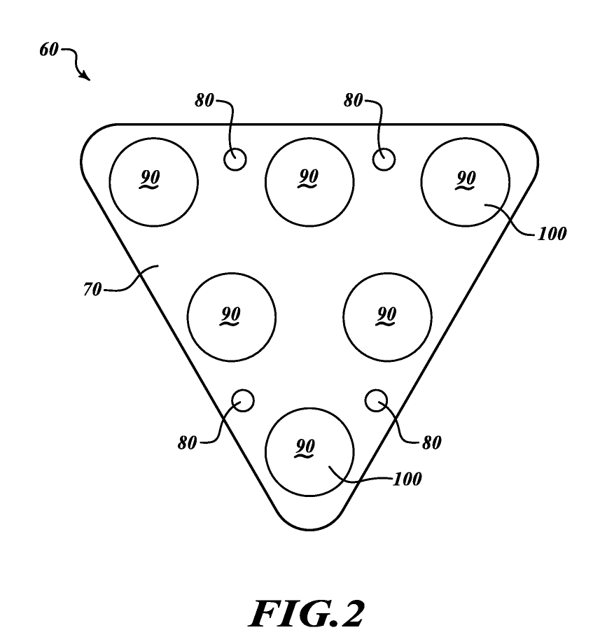

FIG. 2 illustrates a top plan view of a lighting module 60 according to an embodiment and configured to be a constituent element of the assembly 10. The module 60 includes a substantially planar platform member 70, which may be composed of plastic, metal, glass, or a combination of such materials, or any other appropriate material. The module 60 further includes a plurality of light-emitting diodes (LEDs) 90 disposed on the platform member 70. In an embodiment, the LEDs 90 may include a combination of one or more of red, green, blue and white LEDs. The module 60 further includes a plurality of optical elements 100 coupled to the LEDs 90, or otherwise situated with respect to the LEDs, so as to refract light emitted by a corresponding one of the LEDs. In an embodiment, the optical elements 100 include collimating lenses, although other types of optical elements can be employed to customize performance of the assembly 10.

The platform member 70 includes at least one attachment element 80, which may take the form of a borehole. As such, the attachment element(s) 80 are configured to enable removable attachment of the platform member 70 to a surface of the main casing 20 by screws (not shown) or other appropriate temporary fasteners.

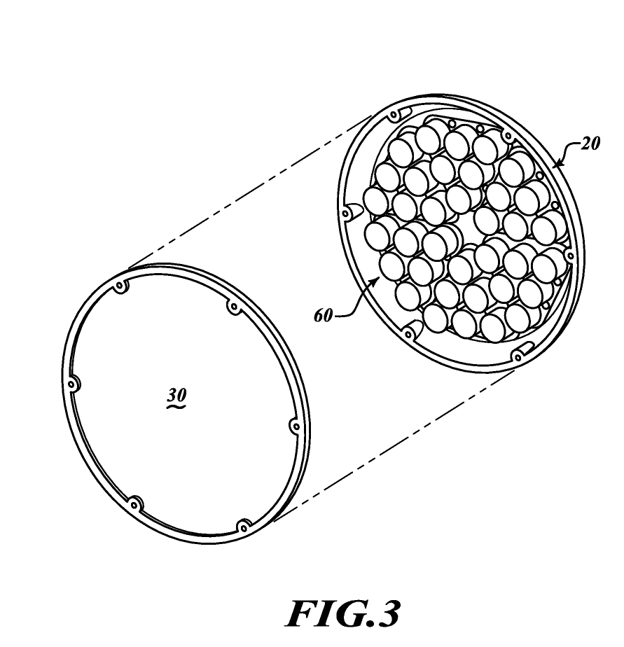

FIG. 3 illustrates an exploded front perspective view of the main casing 20 and primary lens 30. As can be seen in FIG. 3, an embodiment includes an array of lighting modules 60 positioned so as to emit light through the primary lens 30. By virtue of the attachment elements 80 associated with each module 60 of the array, a user of the assembly 10 may conveniently remove a faulty module 60 and replace it with a properly functioning module. Consequently, the assembly 10 need not be discarded altogether should one or more lighting modules 60 fail.

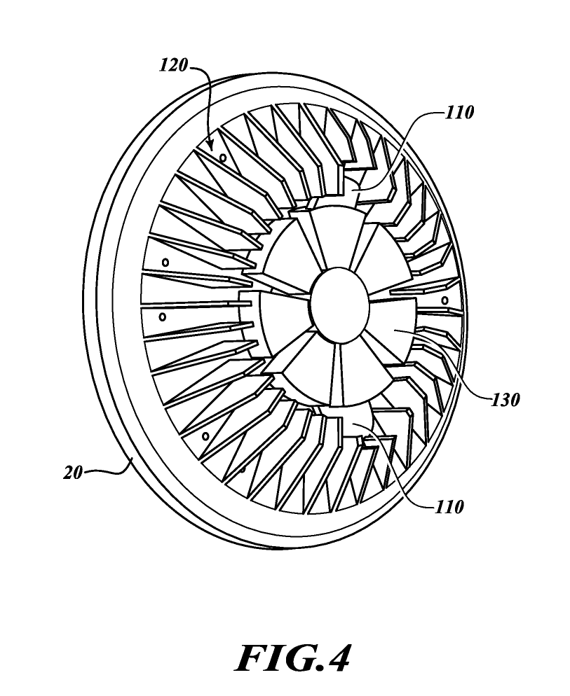

FIG. 4 illustrates a rear perspective view of the main casing 20 on which is formed a cooling assembly including a set of cooling fins 120 and a fan 130 configured to force air over the fins to cool the array of lighting modules 60. As illustrated in FIG. 4, the fins 120 may be radially tapered from the center of the casing 20 to the perimeter of the casing. Such a tapered configuration allows the assembly 10 to fit a PAR-64 profile.

As further illustrated in FIG. 4, the assembly 10 may include one or more control circuits 110 that may control respective ones of the lighting modules 60 and/or individual LEDs 90 of the modules. Such control circuits may employ one or more appropriate control schemes such as, for example, simple resistive control or pulsewidth modulation.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A lighting assembly, comprising:
a first lighting module including a plurality of light-emitting diodes (LEDs) and a plurality of optical elements, each optical element configured to refract light emitted by a corresponding one of the LEDs; and
a cooling assembly adjacent the lighting module and configured to cool the first lighting module.

2. The lighting assembly according to claim 1, further comprising a first control circuit configured to control the first lighting module.

3. The lighting assembly according to claim 1, wherein the optical elements comprise collimating lenses.

4. The lighting assembly according to claim 2, further comprising:
a second lighting module including a plurality of LEDs and a plurality of optical elements; and
a second control circuit configured to control the second lighting module.

5. The lighting assembly according to claim 1, wherein the lighting assembly is of PAR-64 configuration.

6. The lighting assembly according to claim 1, wherein the cooling assembly comprises an array of cooling fins, each fin of the array having a tapered profile.

7. A lighting assembly, comprising:
a first surface;
a first lighting module including a plurality of light-emitting diodes (LEDs) and removably coupled to the first surface; and
a cooling assembly adjacent the at least one lighting module and configured to cool the first lighting module.

8. The lighting assembly according to claim 7, further comprising a first control circuit configured to control the first lighting module.

9. The lighting assembly according to claim 7, further comprising a plurality of optical elements, each optical element configured to refract light emitted by a corresponding one of the LEDs.

10. The lighting assembly according to claim 9, wherein the optical elements comprise collimating lenses.

11. The lighting assembly according to claim 8, further comprising:
a second lighting module including a plurality of LEDs; and
a second control circuit configured to control the second lighting module.

12. The lighting assembly according to claim 7, wherein the lighting assembly is of PAR-64 configuration.

13. The lighting assembly according to claim 7, wherein the cooling assembly comprises an array of cooling fins, each fin of the array having a tapered profile.

14. A lighting module, comprising:
a substantially planar platform member including at least one attachment element, the at least one attachment element configured to enable removable attachment of the platform member to a surface;
a plurality of light-emitting diodes (LEDs) disposed on said platform member; and
a plurality of optical elements, each optical element configured to refract light emitted by a corresponding one of the LEDs.

15. The lighting module according to claim 14, further comprising a first control circuit configured to control the LEDs.

16. The lighting module according to claim 14, wherein the optical elements comprise collimating lenses.
